(19) United States
(12) Patent Application Publication
(10) Pub. No.: US 2011/0234159 A1
(43) Pub. Date: Sep. 29, 2011

(54) CHARGING DEVICE

(75) Inventors: Yosuke Ohtomo, Tokyo (JP); Itaru Seta, Tokyo (JP)

(73) Assignee: FUJI JUKOGYO KABUSHIKI KAISHA, Tokyo (JP)

(21) Appl. No.: 13/022,894

(22) Filed: Feb. 8, 2011

(30) Foreign Application Priority Data
Mar. 25, 2010 (JP) 2010-069363

(51) Int. Cl. H02J 7/04; H02J 7/00

(52) U.S. Cl. 320/109; 320/162

(57) ABSTRACT

When a battery of an electric vehicle charged with an external power source (AC 100 V), the electric vehicle and the external power source are connected with each other by the intermediary of a charging cable. Upon this charging, it is determined whether or not an input voltage from the external power source is 95 V or more. When the input voltage is less than 95 V, that is, a decline of the voltage in the charging cable is large, since a wiring resistance in the charging cable possibly increases, an upper limit of an output power to the battery is reduced. Consequently, the electric power delivered from the external power source can be limited, and thereby excessive heat generation is inhibited and safety is ensured. Furthermore, since the output power is caused to be limited when the wiring resistance possibly increases, the battery can be charged continuously.

### CROSS REFERENCES TO RELATED APPLICATIONS

The present application claims priority from Japanese Patent Application No. 2010-069363 filed on Mar. 25, 2010, and is hereby incorporated by reference in its entirety.

### BACKGROUND OF THE INVENTION

1. Field of the Invention The present invention relates to a charging device that is used by being connected to an external power source.

2. Description of the Related Art

In recent years, electric vehicles which are equipped with an electric motor for propulsion have been under development. The electric vehicle is equipped with an electricity storage device such as battery as well as a charging device, and can be charged with an external power source by connecting the electric vehicle with the external power source by the intermediary of a charging cable. Furthermore, in the field of hybrid electric vehicles that are equipped with an engine and electric motor for propulsion, so called a plug-in type vehicle the electricity storage device of which can be charged with an external powers source is under development (For example, see Japanese Unexamined Patent Application Publication No. 2009-22061).

The electricity storage device mounted on the electric vehicle is often low-resistant and has a high-capacity, and thus when the electricity storage device is charged, high electric current is supplied from an external power source. Accordingly, it is necessary to use a charging cable with a small wiring resistance so as to prevent excessive heat generation at the cable. However, a user possibly connects the charging cable to the external power source via a cord reel or the like, and such act increases a wiring resistance at the input side. Therefore, from a safety point of view, conventional charging devices typically stop charging when an excessive temperature rise is found in the charging cable. However, it requires a long time to charge the electricity storage device mounted on the electric vehicle. Therefore, if charging is simply stopped, a poor charging state is caused in the electricity storage device, which adversely affects the convenience of the electric vehicle.

### SUMMARY OF THE INVENTION

The present invention is made in view of the above, and it is an object of the present invention to charge an electricity storage device while ensuring safety during charging.

According to a first aspect of the present invention, there is provided a charging device which is used by being connected to an external power source and charges an electricity storage device with the external power source. The charging device of the present invention is composed of voltage detection means for detecting an input voltage that is input from the external power source and electric power control means for reducing an upper limit of an output power that is output to the electricity storage device when the input voltage is below a predetermined lower limit.

According to a second aspect of the present invention, in the charging device according to the first aspect, the electric power control means of the charging device of the present invention raises the upper limit of the output power when the input voltage is above the lower limit beyond a predetermined period of time.

According to a third aspect of the present invention, in the charging device according to the first or second aspect, the electricity storage device is an electricity storage device that is mounted on an electric vehicle. According to the present invention, the output power to the electricity storage device is raised when the input voltage from the external power source is below the lower limit. Accordingly, the input power delivered from the external power source can be reduced in a case that an increase in the wiring resistance at the input side is suspected. Therefore, it is possible to continuously charge the electricity storage device while inhibiting excessive heat generation at the input side.

### BRIEF DESCRIPTION OF THE DRAWINGS

FIG. 1 is a schematic view showing a configuration of an electric vehicle.

FIG. 2 is an explanatory view showing an example of a charging situation of the electric vehicle.

FIG. 3 is a flow chart showing a procedure of a power limit processing for switching an upper limit of output power.

FIG. 4 is an explanatory view showing an outline of the power limit processing.

FIG. 5A is an explanatory view showing an example of an heat generation state in a connection line when the upper limit is set at 1000 W, and FIG. 5B is an explanatory view showing an example of an heat generation state in the connection line when the upper limit is set at 600 W.

### DESCRIPTION OF THE PREFERRED EMBODIMENTS

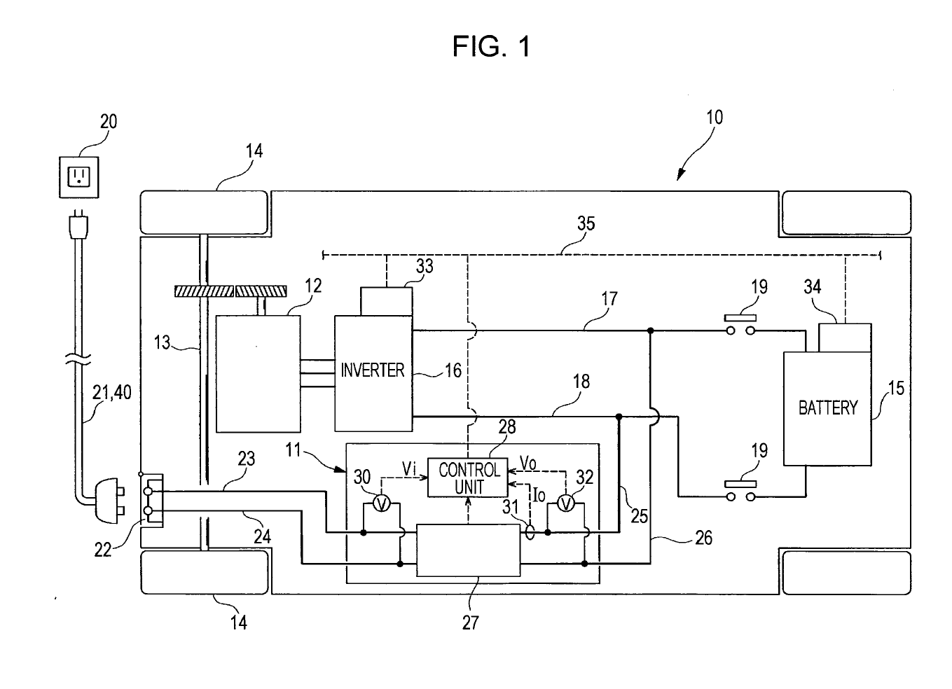

An embodiment of the present invention will hereunder be described with reference to the drawings. FIG. 1 is a schematic view showing a configuration of an electric vehicle 10. The electric vehicle 10 is equipped with a charging device 11 that is an embodiment of the present invention. As shown in FIG. 1, the electric vehicle 10 includes a motor-generator 12 which is connected to drive wheels by the intermediary of a drive axle 13. Furthermore, the electric vehicle 10 has a battery 15 as the electricity storage device which is connected to the motor-generator 12 by the intermediary of an inverter 16. Each of conducting lines 17 and 18 that connect the battery 15 and inverter 16 is provided with a main relay 19.

The electric vehicle 10 is provided with a charge socket 22 for connecting a charge cable 21 in order to charge the battery 15 with an external power source 20 (for example, AC 100 V). The charging device 11 mounted on the electric vehicle 10 converts supplied power from the external power source 20 to charging power. An input side of the charging device 11 is connected to the charge socket 22 by the intermediary of input lines 23 and 24, and an output side of the charging device 11 is connected to the conducting lines 17 and 18 by the intermediary of output lines 25 and 26. The charging device 11 also has a power converting unit 27 that is configured with a rectifier circuit, an electric transformer, a switching circuit and the like, and low-voltage alternate current is converted to high-voltage direct current through the power converting unit 27. Furthermore, the charging device 11 has a control unit 28, and the power converting unit 27 is controlled based on a control signal output from the control unit 28. The charging device 11 is equipped with a voltage sensor 30 that detects a voltage of the input lines 23 and 24, a current sensor 31 that detects current of the output lines 25 and 26 and a voltage sensor 32 that detects a voltage of the output lines 25 and 26. Voltage and current signals from the sensors 30 to 32 are transmitted to the control unit 28.

The electric vehicle 10 is provided with a motor control unit 33 that controls the inverter 16, a battery control unit 34 that controls the battery 15 and the like. Furthermore, a communication network 35 is built in the electric vehicle 10. The charging device 11, the motor control unit 33, the battery control unit 34 and the like are connected to each other via the communication network 35.

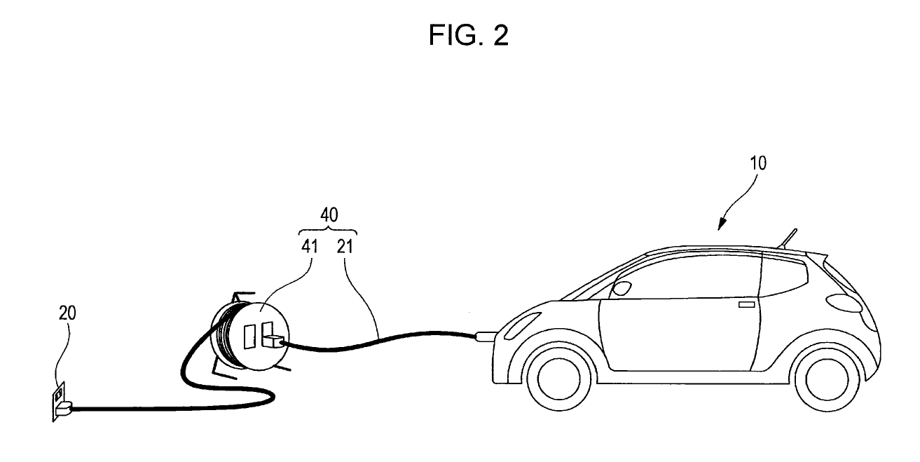

FIG. 2 is an explanatory view showing an example of a charging situation of the electric vehicle 10. As shown in FIG. 1, upon charging the battery 15 of the electric vehicle 10, firstly the external power source 20 and the electric vehicle 10 are connected to each other by the intermediary of the charging cable 10. It is necessary to use a charging cable with a small wiring resistance as the charging cable 21 so as to prevent excessive heat generation at the charging cable 21. However, for a connection line 40 a user possibly uses a charging cable with a large wiring resistance instead of the charging cable 21 that satisfies a predetermined quality requirement or, as shown in FIG. 2, a cord reel 41 in addition to the charging cable 21. As described, it can be assumed the connection line 40 between external power source 20 and the electric vehicle 10 will have a considerably large wiring resistance, and thus it has been necessary to detect the heat generation state in the connection line 40 and stop charging according to the heat generation state. However, since the connection line 40 is configured with various cables and the like, it was extremely difficult to detect the heat generation state in the connection line 40. Furthermore, if charging is simply stopped according to the heat generation state in the connection line 40, a poor charge state occurs in the battery 15, which adversely affected the convenience of the electric vehicle 10.

Thus, the control unit 28, which functions as the electric power control means, switches an upper limit Pmax of an output power Po that is output from the charging device 11 to the battery 15 based on an input voltage Vi that in input from the external power source 20 to the charging device 11, so as to prevent excessive heat generation in the connection line 40, while continuously charging the battery 15. The control unit 28 receives the value of input voltage Vi from the voltage sensor 30, which serves as the voltage detection means. In addition, the control unit 28 receives the value of output current Io from the current sensor 31 and the value of output voltage Vo from the voltage sensor 32. Based on these detected values, the control unit 28 calculates the output power Po. In the following description, the upper limit Pmax of the output power Po is set with four stages of 400 W, 600 W, 800 W, and 1000 W. However, the present invention is not limited thereto. The upper limit Pmax may be set with three or less stages or with five or more stages.

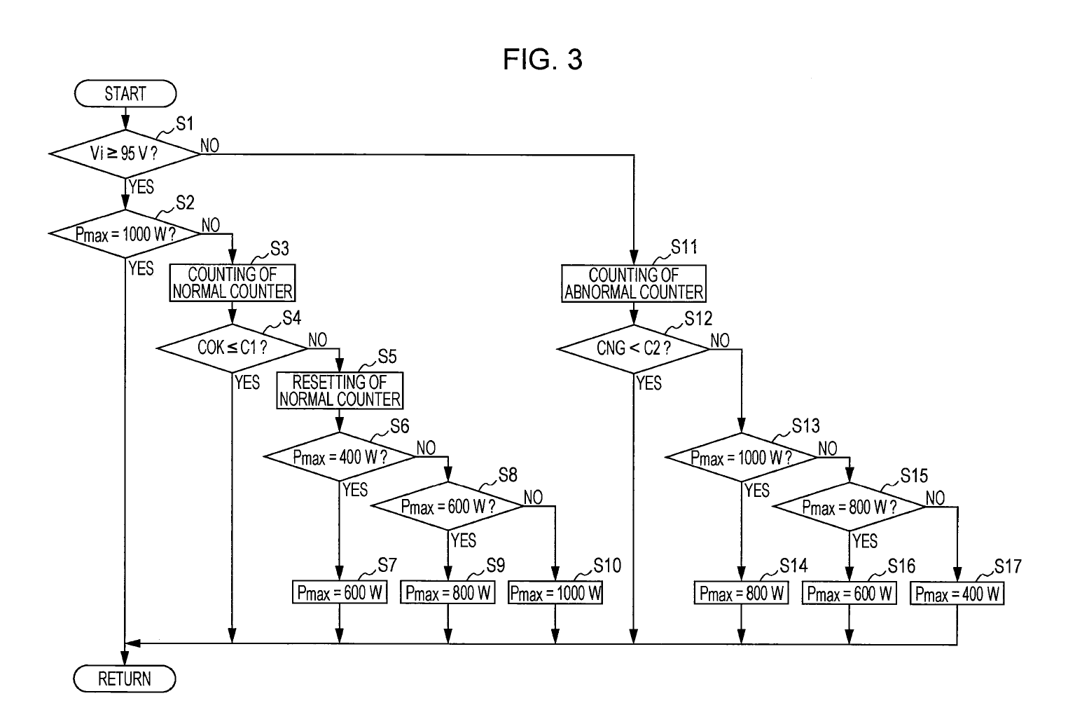

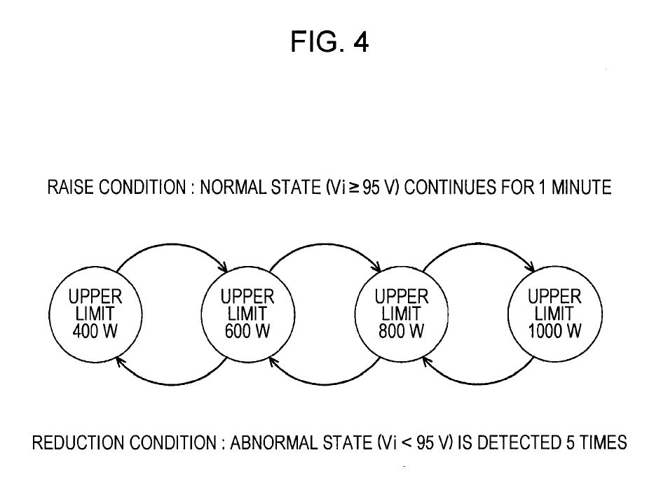

FIG. 3 is a flow chart showing a procedure of a power limit processing for switching the upper limit Pmax of the output power Po. FIG. 4 is an explanatory view showing an outline of the power limit processing. The power limit processing shown in FIG. 3 is executed at a predetermined interval (for example, every 100 msec). As shown in FIG. 3, in step S1, it is determined whether or not the input voltage Vi to the charging device 11 is the lower limit of 95 V or more in order to determine the wiring resistance in the connection line 40. Specifically, when the input voltage Vi is 95 V or more, a normal state where the wiring resistance is below a predetermined acceptable value is confirmed since a decline of the voltage in the connection line 40 is small. On the other hand, when the input voltage Vi is below 95 V, an abnormal state where the wiring resistance is above the predetermined acceptable value is confirmed since a decline of the voltage in the connection line 40 is large. Here, the lower limit Vmin of the input voltage Vi is set at 95 V but the present invention is not limited thereto.

In step S1, when the input voltage Vi is determined to be 95 V or more, a determination is started from step S2 for raising the upper limit Pmax since the normal state where the decline in the input voltage Vi is small is confirmed. In step S2, it is determined whether or not the upper limit Pmax is currently a maximum of 1000 W. When the upper limit Pmax is determined to the maximum of 1000 W in step S2, the process exits the routine while maintaining the upper limit Pmax of 1000 W. When the upper limit Pmax is determined to be other than 1000 W, the process proceeds to step S3, and counting of a normal counter COK is executed. In following step S4, it is determined whether or not the value of the normal counter COK is a predetermined value C1 or less. When the value of the normal counter COK is determined to be the predetermined value C1 or less in step S4, the process exits the routine while maintaining the current value of the upper limit Pmax. When the value of the normal counter COK is determined to exceed the predetermined value C1, the process proceeds to step 5, and resetting of the normal counter COK is executed. The predetermined value C1 is set to a count number that corresponds to one minute. It is permitted to proceed to step S5 when the normal state in which the input voltage Vi is 95 V or more continues for one minute.

After resetting of the normal counter COK is executed in step S5, the process proceeds step S6 to determine whether or not the upper limit Pmax is currently 400 W. When the upper limit Pmax is determined to be 400 W in step S6, the process proceeds to step S7 to raise the upper limit Pmax to 600 W, and then the process exits the routine. On the other hand, when the upper limit Pmax is determined to be other than 400 W in step S6, the process proceeds to step S8 to determined whether or not the upper limit Pmax is 600 W. When the upper limit Pmax is determined to be 600 W in step S8, the process proceeds to step S9 to raise the upper limit Pmax to 800 W from 600 W, and then the process exits the routine. On the other hand, when upper limit Pmax is determined to other than 600 W in step S8, that is the upper limit Pmax is currently 800 W, the process proceeds to step 10 to raise the upper limit Pmax to 1000 W from 800 W, and then the process exits the routine.

When the input voltage Vi is determined to be less than 95V in step S1, a determination is started from step S11 for reducing the upper limit Pmax since the abnormal state is confirmed where the decline in the input voltage Vi is large. In step S11, counting of an abnormal counter CNG is executed, and in following step S12, it is determined whether or not the value of the abnormal counter CNG is less than a predetermined value C2. When the value of the abnormal counter CNG is determined to be less than the predetermined value C2, the process exits the routine while maintaining the current value of the upper limit Pmax. On the other hand, when the value of the abnormal counter CNG is determined to be above the predetermined value C2, the process proceeds to S13 to determine whether or not the upper limit Pmax is currently 1000 W. The predetermined value C2 is set to five for example, and it is permitted to proceed to step 13 when the abnormal state where the input voltage Vi is less than 95 V is detected five times. Specifically, in the case that an execution cycle of the power limit processing is 100 msec, the process proceeds to step S13 when the abnormal state where the input voltage Vi is less than 95 V continues for 0.5 seconds.

When the upper limit Pmax is determined to be 1000 W in step S13, the process proceeds to step S14 to reduce the upper limit Pmax to 800 W from 1000 W, and then the process exits the routine. On the other hand, when the upper limit Pmax is determined to be other than 1000 W in step S13, the process proceeds to step S15 to determine whether or not the upper limit Pmax is currently 800 W. When the upper limit Pmax is determined to be 800 W in step S15, the process proceeds to step S16 to reduce the upper limit to 600 W from 800 W, and then the process exits the routine. On the other hand, when the upper limit Pmax is determined to be other than 800 W in step S15, that is, the upper limit Pmax is determined to be currently 600 W, the process proceeds to step S17 to reduce the upper limit Pmax to 400 W from 600 W, and then the process exits the routine.

Specifically, as shown in FIG. 4, when the input voltage Vi to the charging device 11 is less than 95 V is detected five times, the upper limit Pmax of the output power Po output from the charging device 11 to the battery 15 is reduced by one stage. As described, since the upper limit Pmax of the output power Po is caused to be reduced in the abnormal state where an increase in the wiring resistance in the connection line 40 is suspected, electric power delivered from the external power source 20 via the connection line 40 can be limited, thereby inhibiting excessive heat generation in the connection line 40. On the other hand, when the normal state where the input voltage Vi to the charging device 11 is 95 V or more continues for one minute, the upper limit Pmax of the output power Po output from the charging device 11 to the battery 15 is raised by one stage. As described, the upper limit Pmax of the output power Po is caused to be raised in the normal state where the wiring resistance in the connection line 40 is small.

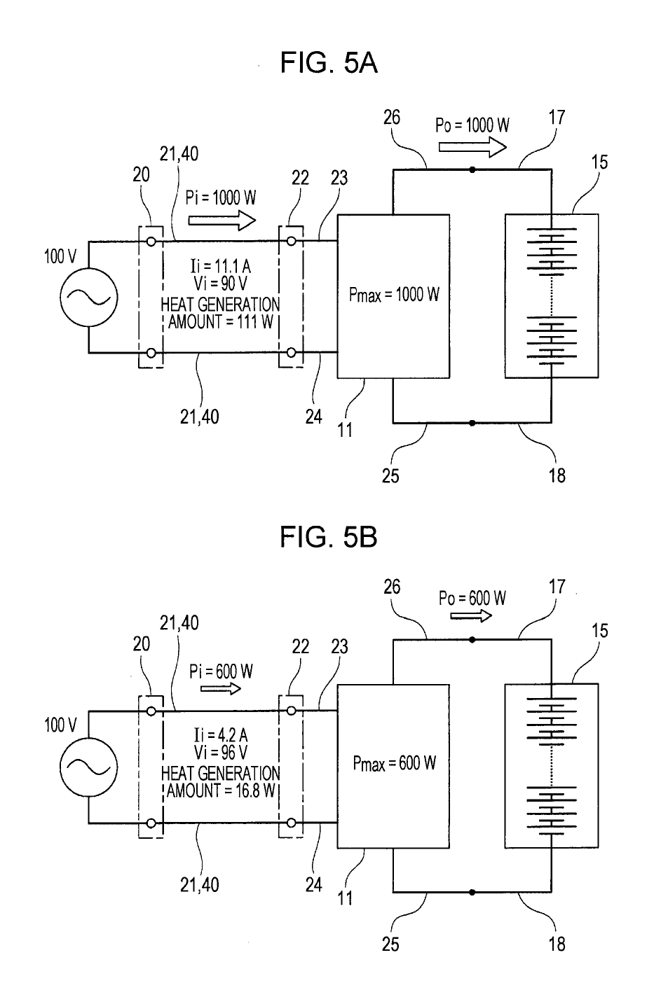

FIG. 5A is an explanatory view showing an example of an heat generation state in the connection line 40 when the upper limit Pmax is set at 1000 W, and FIG. 5B is an explanatory view showing an example of an heat generation state in the connection line 40 when the upper limit Pmax is set at 600 W. For easy understanding, the conversion efficiency of the charging device 11 is assumed to be 100 percent in FIGS. 5A and 5B. As shown in FIG. 5A, when the output power Po to the battery 15 is 1000 W, that is, the input power Pi delivered from the external power source 20 is 1000 W, and the input voltage Vi to the charging device 11 is 90 V, input current Ii that flows through the connection line 40 is approximately 11.1 A (=1000 W/90 V). As this time, since the voltage drop in the connection line 40 is 10 V (=100 V−90 V), the heat generation amount in the connection line 40 is approximately 111 W (=11.1 A×10 V). When the output power Po is limited to 600 W from this condition by reducing the upper limit Pmax to 600 W, the input power Pi is also reduced to 600 w. Thus, while the input voltage is recovered, the input current Ii is decreased. As described, supposing that the input voltage Vi is recovered to 96 V by limiting the output voltage Po to 600 W, the input current Ii is decreased to approximately 4.2 A (=600 W/96 V). As this time, since the voltage drop in the connection line 40 is 4V (=100 V−96 V), the heat generation amount in the connection line 40 is reduced to approximately 16.8 W (=4.2 A×4 V).

As described, when an increase in the wiring resistance in the connection line 40 is suspected due to a substantial decrease in the input voltage Vi, the upper limit Pmax of the output power Po is caused to be reduced. Consequently, the input power Pi delivered from the external power source 20 can be limited, and thereby the heat generation amount in the connection line 40 can be reduced. Furthermore, even in the case that the upper limit Pmax of the output power Po is reduced, the upper limit Pmax of the output power Po is caused to be raised when the input voltage Vi is recovered to a normal range. Consequently, even in the case that the input voltage Vi is temporarily decreased due to another electric load connected to the external power source 20, the output power Po can be recovered in accordance with the recovery of the input voltage Vi.

As described above, since the upper limit Pmax is caused to be increased or decreased based on the input voltage Vi, the input power Pi can be secured to the maximum, within the extent that excessive heat generation is not caused in the connection line 40. Consequently, the battery 15 can be quickly charged while ensuring safety during charging, and convenience of the electric vehicle 10 can be enhanced while avoiding a lack of charging of the battery 15. Furthermore, when the upper limit Pmax is reduced, it is caused to be reduced quickly simply after the abnormal state of the input voltage Vi is detected a predetermined number of times (for example, five times). On the other hand, in the case the upper limit Pmax is raised, it is caused to be carefully raised after it is confirmed that the normal state of the input voltage Vi continues for a predetermined period of time (for example, one minute). Consequently, safety during charging can be enhanced.

Of course the present invention is not limited to the above-mentioned embodiment and various changes may be made without departing from the scope of the invention. In the above description, the upper limit Pmax of the output power Po is caused to be reduced to 400 W. However, the present invention is not limited to this, and the upper limit Pmax may be reduced to 0 W to discontinue charging. Further, in the above description, the upper limit Pmax of the output power is predetermined. However, the present invention is not limited to this, and the upper limit Pmax may be calculated based on the input voltage Vi. Furthermore, in the above description, the upper limit Pmax is caused to be reduced when the abnormal state where the input voltage Vi is decreased is detected five times. However, the present invention is not limited to this, and the upper limit Pmax may be reduced when the abnormal state is detected just once.

The illustrated electric vehicle 10 is an electric vehicle which only has the motor-generator 12 as a driving source, but may be a hybrid-type electric vehicle that includes a motor-generator and an engine as driving sources. Further, the charging device 11 is mounted on the electric vehicle 10, but the present invention is not limited to this and may be applied to a charging device that is provided independently. Furthermore, the battery 15 comprised of a lithium-ion rechargeable battery, a nickel metal hydride rechargeable battery or the like is used as the electricity storage device, but the present invention is not limited to this and a capacitor such as a lithium-ion capacitor and an electric double layer capacitor may be used as the electricity storage device. Furthermore, the charging device 11 charges the battery 15 for the electric vehicle 10, but the present invention may be applied to a charging device that is designed to charge an electricity storage device for a different electric equipment. Furthermore, in the above description, a commercial power supply of AC 100 V is used as the external power source 20. However, the present invention is not limited to this, and a commercial power supply of AC 200 V may be used as the external power source 20. Furthermore, a solar panel, a wind generator, a fuel cell, an accumulator or the like may be used as the external power source.

What is claimed is:

1. A charging device which is used by being connected to an external power source and charges an electricity storage device with the external power source comprising:
voltage detection means for detecting an input voltage that is input from the external power source; and
electric power control means for reducing an upper limit of an output power that is output to the electricity storage device when the input voltage is below a predetermined lower limit.

2. The charging device according to claim 1, wherein the electric power control means raises the upper limit of the output power when the input voltage is above the lower limit beyond a predetermined period of time.

3. The charging device according to claim 1, wherein the electricity storage device is an electricity storage device that is mounted on an electric vehicle.

4. The charging device according to claim 2, wherein the electricity storage device is an electricity storage device that is mounted on an electric vehicle.
